(19) United States
(12) Patent Application Publication
(10) Pub. No.: US 2015/0161598 A1
(43) Pub. Date: Jun. 11, 2015

(54) ASSIGNING DESCRIPTORS TO TRANSACTIONS

(71) Applicant: International Business Machines Corporation, Armonk, NY (US)

(72) Inventors: Martin J. Gale, Eastleigh (GB); Nigel L. Hopper, Bishopstoke (GB); Matthew Whitbourne, Horndean (GB)

(73) Assignee: International Business Machines Corporation, Armonk, NY (US)

(21) Appl. No.: 14/102,710

(22) Filed: Dec. 11, 2013

(51) Int. Cl. G06Q 20/38

(52) U.S. Cl. CPC G06Q 20/38

(57) ABSTRACT

A transaction is received containing a plurality of sub-transactions. Each of the plurality of sub-transactions is associated with a category and a value. Each of the sub-transactions is assigned to one of a plurality of groups based on the associated category. A total value of the sub-transactions for each group is calculated. A dominant group is calculated based on the calculated total value of the sub-transactions for each group. The merchant identification descriptor associated with the dominant group is assigned to the transaction. The transaction is submitted to a payment merchant with the assigned merchant identification descriptor. The transaction may be split into multiple transactions with each assigned a merchant identification descriptor.

### BACKGROUND

The present disclosure relates to the field of transaction processing and more particularly to categorization of transactions based on sub-transactions.

Internet banking services are providing financial analysis capabilities to allow customers to gain broader insight into their spending habits to better manage their finances. Some of these services allow customers to categorize particular transactions and utilize the user categorization for future transactions. Some of these services also automatically attempt to categorize transactions based on known vendors.

### SUMMARY

Described herein are embodiments of a method for processing transactions by a commerce engine. The method includes receiving a transaction. The transaction contains a plurality of sub-transactions. Each of the plurality of sub-transactions is associated with a category. Each of the plurality of sub-transactions is associated with a value. The method further includes determining the associated category for each of the plurality of sub-transactions. The method further includes assigning each of the plurality of sub-transactions to one of a plurality of groups based on the associated category. The method further includes calculating a total value of the sub-transactions for each group in the plurality of groups. The method further includes determining a dominant group from the plurality of groups. The determining a dominant group based on the calculated total value of the sub-transactions for each group. The method further includes assigning a merchant identification descriptor to the transaction. The merchant identification descriptor is associated with the sub-transactions in the dominant group. The method further includes transmitting the transaction to a payment merchant with the assigned merchant identification descriptor.

Also described herein are embodiments of another method for processing transactions by a commerce engine. The method includes receiving a first transaction. The first transaction contains a plurality of sub-transactions. Each of the plurality of sub-transactions is associated with a category. Each of the plurality of sub-transactions is associated with a value. The method further includes determining the associated category for each of the plurality of sub-transactions. The method further includes assigning each of the plurality of sub-transactions to one of a plurality of groups based on the associated category. The method further includes creating two or more transactions from the first transaction based on the plurality of groups. The method further includes assigning merchant identification descriptors to each of the two or more transactions. The merchant identification descriptors are associated with the sub-transactions in each of the two or more transactions. The method further includes transmitting the two or more transactions to a payment merchant with the assigned merchant identification descriptors.

Also described herein are embodiments of a computer system. The computer system includes one or more processors, one or more computer-readable memories, one or more computer-readable tangible storage devices, and program instructions stored on at least one of the one or more storage devices for execution by at least one of the one or more processors via at least one of the one or more memories. The program instructions for execution include program instructions to receive a transaction. The transaction contains a plurality of sub-transactions. Each of the plurality of sub-transactions is associated with a category. Each of the plurality of sub-transactions is associated with a value. The program instructions for execution further include program instructions to determine the associated category for each of the plurality of sub-transactions. The program instructions for execution further include program instructions to assign each of the plurality of sub-transactions to one of a plurality of groups based on the associated category. The program instructions for execution further include program instructions to calculate a total value of the sub-transactions for each group in the plurality of groups. The program instructions for execution further include program instructions to determine a dominant group from the plurality of groups. The determining the dominant group is based on the calculated total value of the sub-transactions for each group. The program instructions for execution further include program instructions to assign a merchant identification descriptor to the transaction. The merchant identification descriptor is associated with the sub-transactions in the dominant group. The program instructions for execution further include program instructions to transmit the transaction to a payment merchant with the assigned merchant identification descriptor.

### BRIEF DESCRIPTION OF THE DRAWINGS

FIG. 1 depicts a flow diagram of an example method for categorizing transactions.

FIG. 2 depicts a flow diagram of an example method for categorizing transactions.

FIG. 3 depicts a block diagram of an example system for implementing embodiments of the invention.

FIG. 4 depicts a high-level block diagram of an example system for implementing one or more embodiments of the invention.

### DETAILED DESCRIPTION

In this detailed description, reference is made to the accompanying drawings, which illustrate example embodiments. It is to be understood that other embodiments may be utilized and structural changes may be made without departing from the scope of the disclosure. The terminology used herein is for the purpose of describing particular embodiments only and is not intended to be limiting. In accordance with disclosed features, a method, system, and computer program product are provided for categorizing transactions.

Embodiments of the current invention may provide for categorization of transactions at the point of sale. Transactions may be assigned a merchant identification descriptor based on the sub-transactions which make up the transaction. This may allow for a merchant identification descriptor which more specifically describes the transaction. In some embodiments, the descriptor may represent a dominant group of sub-transactions. In some embodiments, separate transaction may be created with different descriptors. A merchant may be able to modify rules which determine what constitutes a dominant group or how transactions will be separated and assigned descriptors.

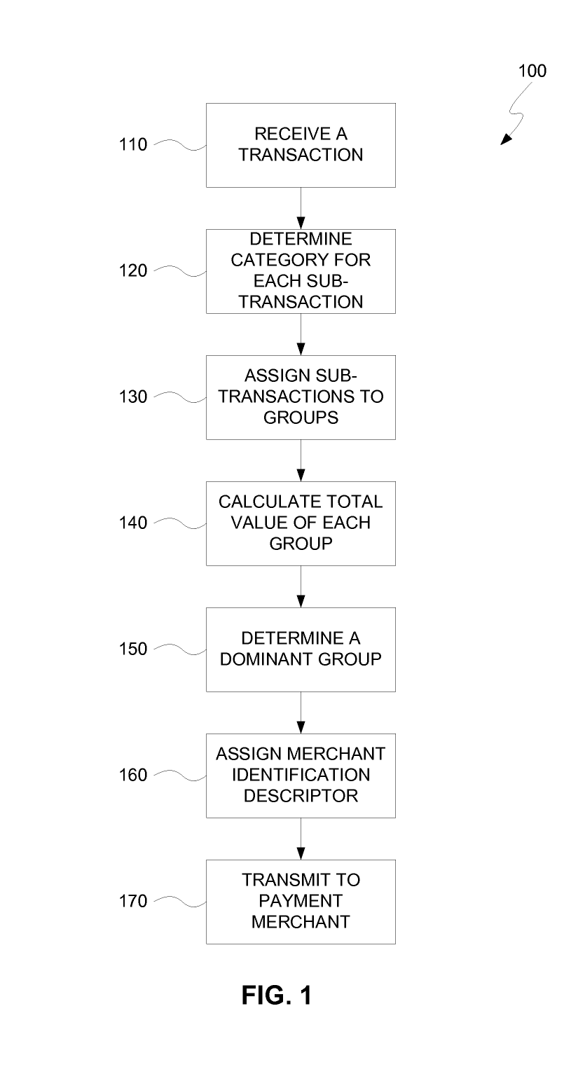

FIG. 1 depicts a flow diagram 100 of an example method for categorizing transactions. At step 110, a transaction is received which contains multiple sub-transactions. For example, a sub-transaction may include a specific item or multiple of the same item and the price of those items. At step 120, categories for each of the sub-transactions are determined. In some embodiments, the categories may be retrieved using the stock keeping unit (SKU) categorization within a shop inventory system. The categories could be determined at different levels as set by the merchant. For example, a category for a sub-transaction for apples may be “fruit” or may be “groceries”.

At step 130, the sub-transactions may be assigned to groups based on their categories. The groups may contain sub-transactions which have the same category or may contain sub-transactions which have similar categories. At step 140, a total value of the sub-transactions may be calculated for each group. The value may include the total price of each item represented in the sub-transactions. In some embodiments this may also include a prorated portion of the sales tax or other fees. At step 150, a dominant group of sub-transactions may be determined based on a set of rules. In some embodiments, the dominant group may be the group which contains the highest value of sub-transactions. In some embodiments, the value of the sub-transactions in a group must exceed a specified percentage of the total value of the transaction to become the dominant category. The specified percentage may be modified by the merchant in some embodiments. In some embodiments, the dominant group may be the group which contains the most sub-transactions or the most items. The rules for determining a dominant group may be configurable by the merchant.

At step 160, a merchant identification descriptor may be assigned to the transaction. The merchant identification descriptor may be associated with the sub-transactions of the dominant group. The merchant identification descriptor may indicate a category which describes the dominant group. This may be the category which all of the sub-transactions were assigned or a more general category which encompasses the assigned categories. The merchant identification descriptor may contain identification information for the merchant such as a name and phone number. In some embodiments, the merchant identification descriptor is a dynamic soft descriptor which may be updated to describe the sub-transactions in the dominant group. At step 170, the transaction may be transmitted to a payment merchant with the assigned merchant identification descriptor.

For example a transaction may include the following sub-transactions: $100-Television, $50-Audio Player, $10-Pizza, $5-Apples. The category for the Television and Audio Player may be “electronics”. The category for the Pizza and Apples may be “groceries.” The Television and Audio Player may be grouped together in a first group and the Pizza and Apples may be grouped together in a second group. The total value of the first group is $150 and the total value of the second group is $15. The first group may be the dominant group because $150 is greater than $15. A merchant identification descriptor may be assigned to the transaction which represents the first group such as “MerchantName: Electronics,” where MerchantName is an identification of the merchant. The merchant identification descriptor may include “Electronics+Other” to show that there were items which were not electronics.

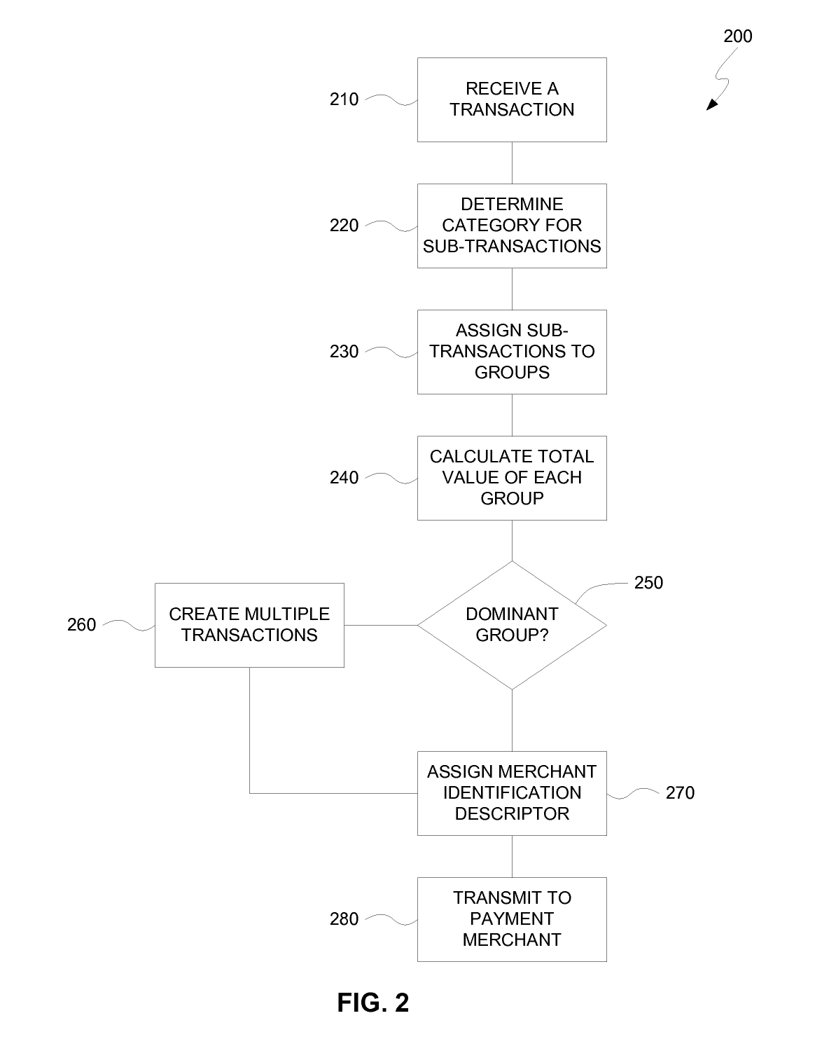

FIG. 2 depicts a flow diagram 200 of an example method for categorizing transactions. At step 210, a transaction is received which contains multiple sub-transactions. At step 220, categories for each of the sub-transactions are determined. In some embodiments, the categories may be retrieved using the stock keeping unit (SKU) categorization within a shop inventory system. At step 230, the sub-transactions may be assigned to groups based on their categories. The groups may contain sub-transactions which have the same category or may contain sub-transactions which have similar categories. At step 240, a total value of the sub-transactions may be calculated for each group.

At step 250, it is determined whether there is a dominant group. This may include determining if there is a group whose total value meets a threshold of the total value of the whole transaction. For example, a group may be the dominant group if the total value is at least 70% of the value of the total transaction.

If there is no dominant group, at step 260, the groups may be used to create multiple transactions. Rules, which may be configurable by the merchant, may be applied to determine the multiple transactions. In some embodiments, multiple transactions are created without determining if there is a dominant group. In some embodiments, the customer may be given the option to create multiple transactions at the point of sale. This may allow the merchant to pass on additional costs to the customer which are created by having multiple transactions. Transactions may be created for each group of sub-transactions. In some embodiments, if groups of sub-transactions have a total value less than a specified percentage of the total transaction they may be combined in a transaction later assigned a generic descriptor.

At step 270, merchant identification descriptors may be assigned to the one or more transactions. The merchant identification descriptor may be associated with the dominant group for the single transaction if a dominant group was determined. The merchant identification descriptor may be associated with the sub-transactions in the respective transaction if multiple transactions are created. In some embodiments, if there is no dominant category the sub-transactions may be grouped in a single transaction and assigned a generic merchant identification descriptor. At step 280, the one or more transactions may be transmitted to a payment merchant with the assigned merchant identification descriptors.

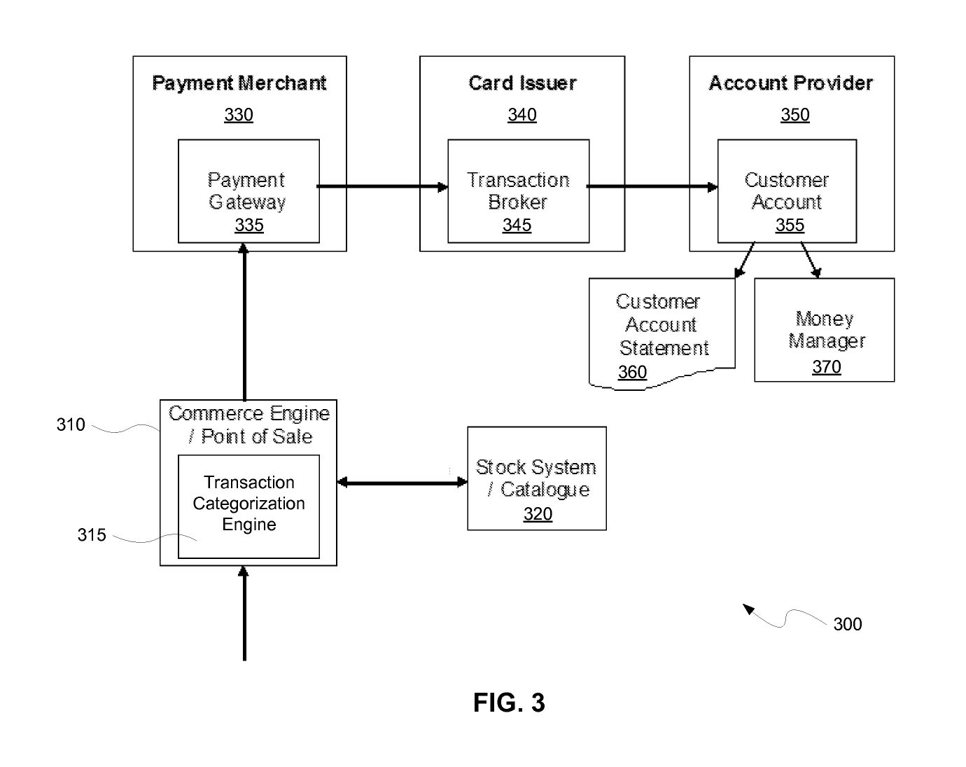

FIG. 3 depicts a block diagram 300 of an example system for implementing embodiments of the invention. A shopping purchase may occur and the transaction enters commerce engine 310. Within block 310 is transaction categorization engine 315. Transaction categorization engine 315 may retrieve categories for sub-transactions from stock system 320. Transaction categorization engine 315 may group sub-transactions based on the retrieved categories. Transaction categorization engine 315 may determine if there is a dominant group or may create two or more transactions as described previously. Transaction categorization engine 315 may assign a merchant identification descriptor to each transaction which is associated with the dominant group or sub-transactions. Commerce engine 310 may transmit the transactions with the assigned merchant identification descriptors to payment merchant 330.

Payment gateway 335 may communicate the transactions to card issuer 340. Transaction Broker 345 may process the transactions and communicate the transaction to account provider 350. The transactions may be applied to the customer account 355. A customer account statement 360 may be created which indicates the transactions and the assigned merchant identification descriptors. Money manager 370 may take the transactions and categorize them using the assigned merchant identification descriptors.

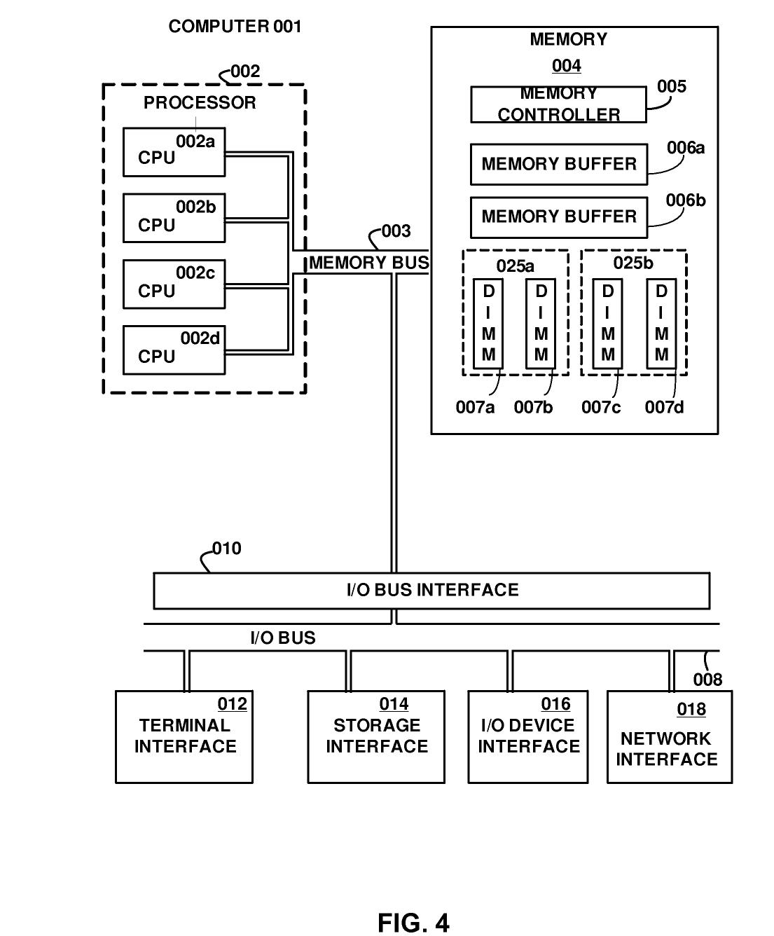

FIG. 4 depicts a high-level block diagram of an example system for implementing one or more embodiments of the invention. The mechanisms and apparatus of embodiments of the present invention apply equally to any appropriate computing system. The major components of the computer system 001 comprise one or more CPUs 002, a memory subsystem 004, a terminal interface 012, a storage interface 014, an I/O (Input/Output) device interface 016, and a network interface 018, all of which are communicatively coupled, directly or indirectly, for inter-component communication via a memory bus 003, an I/O bus 008, and an I/O bus interface unit 010.

The computer system 001 may contain one or more general-purpose programmable central processing units (CPUs) 002A, 002B, 002C, and 002D, herein generically referred to as the CPU 002. In an embodiment, the computer system 001 may contain multiple processors typical of a relatively large system; however, in another embodiment the computer system 001 may alternatively be a single CPU system. Each CPU 002 executes instructions stored in the memory subsystem 004 and may comprise one or more levels of on-board cache.

In an embodiment, the memory subsystem 004 may comprise a random-access semiconductor memory, storage device, or storage medium (either volatile or non-volatile) for storing data and programs. In another embodiment, the memory subsystem 004 may represent the entire virtual memory of the computer system 001, and may also include the virtual memory of other computer systems coupled to the computer system 001 or connected via a network. The memory subsystem 004 may be conceptually a single monolithic entity, but in other embodiments the memory subsystem 004 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 004 may contain elements for control and flow of memory used by the CPU 002. This may include all or a portion of the following: a memory controller 005, one or more memory buffer 006 and one or more memory devices 007. In the illustrated embodiment, the memory devices 007 may be dual in-line memory modules (DIMMs), which are a series of dynamic random-access memory (DRAM) chips 015a-015n (collectively referred to as 015) mounted on a printed circuit board and designed for use in personal computers, workstations, and servers. The use of DRAMs 015 in the illustration is exemplary only and the memory array used may vary in type as previously mentioned. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 004 in the computer system 001. In other embodiments the components may be arranged differently and have a variety of configurations. For example, the memory controller 005 may be on the CPU 002 side of the memory bus 003. In other embodiments, some or all of them may be on different computer systems and may be accessed remotely, e.g., via a network.

Although the memory bus 003 is shown in FIG. 4 as a single bus structure providing a direct communication path among the CPUs 002, the memory subsystem 004, and the I/O bus interface 010, the memory bus 003 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 010 and the I/O bus 008 are shown as single respective units, the computer system 001 may, in fact, contain multiple I/O bus interface units 010, multiple I/O buses 008, or both. While multiple I/O interface units are shown, which separate the I/O bus 008 from various communications paths running to the various I/O devices, in other embodiments some or all of the I/O devices are connected directly to one or more system I/O buses.

In various embodiments, the computer system 001 is a multi-user mainframe computer system, a single-user system, or a server computer or similar device that has little or no direct user interface, but receives requests from other computer systems (clients). In other embodiments, the computer system 001 is implemented as a desktop computer, portable computer, laptop or notebook computer, tablet computer, pocket computer, telephone, smart phone, network switches or routers, or any other appropriate type of electronic device.

FIG. 4 is intended to depict the representative major components of an exemplary computer system 001. But individual components may have greater complexity than represented in FIG. 4, components other than or in addition to those shown in FIG. 4 may be present, and the number, type, and configuration of such components may vary. Several particular examples of such complexities or additional variations are disclosed herein. The particular examples disclosed are for example only and are not necessarily the only such variations.

The memory buffer 006, in this embodiment, may be intelligent memory buffer, each of which includes an exemplary type of logic module. Such logic modules may include hardware, firmware, or both for a variety of operations and tasks, examples of which include: data buffering, data splitting, and data routing. The logic module for memory buffer 006 may control the DIMMs 007, the data flow between the DIMM 007 and memory buffer 006, and data flow with outside elements, such as the memory controller 005. Outside elements, such as the memory controller 005 may have their own logic modules that the logic module of memory buffer 006 interacts with. The logic modules may be used for failure detection and correcting techniques for failures that may occur in the DIMMs 007. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 006, memory controller 005, CPU 002, and even the DRAM 0015 may use these techniques in the same or different forms. These logic modules may communicate failures and changes to memory usage to a hypervisor or operating system. The hypervisor or the operating system may be a system that is used to map memory in the system 001 and tracks the location of data in memory systems used by the CPU 002. In embodiments that combine or rearrange elements, aspects of the firmware, hardware, or logic modules capabilities may be combined or redistributed. These variations would be apparent to one skilled in the art.

Embodiments described herein may be in the form of a system, a method, or a computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk, a random access memory (RAM), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments are not intended to limit the present invention. Indeed, other alternative hardware and/or program environments may be used without departing from the scope of embodiments of the invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for processing transactions by a commerce engine, the method comprising:
receiving a transaction, the transaction comprising a plurality of sub-transactions, each of the plurality of sub-transactions associated with a category, each of the plurality of sub-transactions associated with a value;
determining the associated category for each of the plurality of sub-transactions;
assigning each of the plurality of sub-transactions to one of a plurality of groups based on the associated category;
calculating a total value of the sub-transactions for each group in the plurality of groups;
determining a dominant group from the plurality of groups, the determining the dominant group based on the calculated total value of the sub-transactions for each group;
assigning a merchant identification descriptor to the transaction, the merchant identification descriptor associated with the sub-transactions in the dominant group; and
transmitting the transaction to a payment merchant with the assigned merchant identification descriptor.

2. The method of claim 1, wherein the determining the associated category for each of the plurality of sub-transactions comprises:
retrieving the associated category from a shop inventory system.

3. The method of claim 1, wherein the assigning the merchant identification descriptor to the transaction comprises:
updating the merchant identification descriptor with a description associated with the sub-transactions in the dominant group, wherein the merchant identification descriptor is a dynamic soft descriptor.

4. A method for processing transactions by a commerce engine, the method comprising:
receiving a first transaction, the first transaction comprising a plurality of sub-transactions, each of the plurality of sub-transactions associated with a category, each of the plurality of sub-transactions associated with a value;
determining the associated category for each of the plurality of sub-transactions;
assigning each of the plurality of sub-transactions to one of a plurality of groups based on the associated category;
creating two or more transactions from the first transaction based on the plurality of groups;
assigning merchant identification descriptors to each of the two or more transactions, the merchant identification descriptors associated with the sub-transactions in each of the two or more transactions; and
transmitting the two or more transactions to a payment merchant with the assigned merchant identification descriptors.

5. The method of claim 4, further comprising:
calculating a total value of the sub-transactions for each group in the plurality of groups; and
determining that there is no dominant group, wherein the creating two or more sets of transactions occurs in response to the determining that there is no dominant group.

6. The method of claim 5, wherein the determining that there is no dominant group comprises:
determining that none of the total values meets a specified percentage of a total value of all of the sub-transactions in the first transaction.

7. The method of claim 4, wherein the determining the associated category for each sub-transaction in the first transaction comprises:
retrieving the associated category for each sub-transaction in the first transaction from a shop inventory system.

8. The method of claim 4, wherein the assigning the merchant identification descriptors comprises:
updating the merchant identification descriptors with a description associated with the sub-transactions in each of the two or more transactions, wherein the merchant identification descriptor is a dynamic soft descriptor.

9. A computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions for execution comprising:
program instructions to receive a transaction, the transaction comprising a plurality of sub-transactions, each of the plurality of sub-transactions associated with a category, each of the plurality of sub-transactions associated with a value;
program instructions to determine the associated category for each of the plurality of sub-transactions;
program instructions to assign each of the plurality of sub-transactions to one of a plurality of groups based on the associated category;
program instructions to calculate a total value of the sub-transactions for each group in the plurality of groups;
program instructions to determine a dominant group from the plurality of groups, the determining the dominant group based on the calculated total value of the sub-transactions for each group;
program instructions to assign a merchant identification descriptor to the transaction, the merchant identification descriptor associated with the sub-transactions in the dominant group; and
program instructions to transmit the transaction to a payment merchant with the assigned merchant identification descriptor.

10. The computer system of claim 9, wherein the program instructions to determine the associated category for each of the plurality of sub-transactions comprises:
program instructions to retrieve the associated category from a shop inventory system.

11. The computer system of claim 9, wherein the program instructions to assign a merchant identification descriptor to the transaction comprises:
program instructions to update the merchant identification descriptor with a description associated with the sub-transactions in the dominant group, wherein the merchant identification descriptor is a dynamic soft descriptor.
